(19) United States
(12) Patent Application Publication
(10) Pub. No.: US 2017/0225823 A1
(43) Pub. Date: Aug. 10, 2017

(54) SHELF READY DISPLAY FOR PACKAGED FOOD PRODUCTS

(71) Applicant: Mars, Incorporated, McLean, VA (US)

(72) Inventors: Jack Forward, Batley (GB); Kelly Stevens, Batley (GB); Richard Kamanca, Paris (FR)

(73) Assignee: Mars, Incorporated, McLean, VA (US)

(21) Appl. No.: 15/423,958

(22) Filed: Feb. 3, 2017

Related U.S. Application Data
(60) Provisional application No. 62/291,431, filed on Feb. 4, 2016.

(51) Int. Cl. B65D 5/56; B65D 77/02; B05D 5/08; B65D 85/60

(52) U.S. Cl. CPC B65D 5/56; B65D 85/60; B65D 77/02; B05D 5/08; B31B 1/90; B31B 2201/9009; B31B 2203/10

(57) ABSTRACT

Packaging containers suitable for the transport, storage and retail display of individually packaged products are provided. The packaging container comprises a base having or being provided with an upper surface sloped from a back end to a front end thereof. The upper surface of the base is provided with one or more discrete areas of a slippery material. Packaging units are also provided comprising the packaging container and a plurality of individually packaged products. The containers and units are readily and easily manufactured and so methods for manufacturing both the container and packaging unit are also provided.

### CROSS REFERENCE TO RELATED APPLICATIONS

This application claims the benefit of U.S. Provisional Patent Application Ser. No. 62/291,431, filed on Feb. 4, 2016, which is incorporated herein by reference in its entirety.

### FIELD

The present disclosure relates generally to transport, shipping and retail display containers for packaged food products.

### BACKGROUND

Packaging containers are conveniently used in many industries to transport and store individually packaged products, including food products such as snacks, confectionery, cereals and pet foods. Such containers may typically be provided with a removable lid or an integral sealed top so that the individually packaged products may be transported within the closed or sealed container from a manufacturing site to a point of retail sale. Once at a retail location, the lid may be removed, or the container otherwise opened, and the entire container may be placed on a shelf and used as a display unit without requiring the removal of the individually packaged products therefrom and their placement/arrangement on a retail shelf. Such displays are quick and easy for retailers to set up and also allow the manufacturer a greater advertising space via the combined printable surface area of the packaging container and individually packaged products.

In order to maximize the impact and viewability of the individually packaged products within the container, the largest face of the individually packaged products are desirably arranged to face out of the container and toward the consumer. Further, when the packaging container is full, the individually packaged products are held toward the front of the packaging container by the sides of the packaging container and by the interaction of the individually packaged products with each other. However, once the first individually packaged product has been removed from the front position of the container, a gap is created between the front of the packaging container and the next individually packaged product. As additional products are removed, the gap increases and it may become difficult for a consumer to see the individually package products, or the display may appear unattractive, messy, or even empty.

Packaging containers have been provided that allow for the movement of individually packaged products within the packaging containers. However, such conventional containers are overly complex, and therefore require excessive time and cost to implement, and/or require the use of excessive amounts of materials that may also require specialized equipment to place. The art would benefit from packaging containers and units that address these needs more efficiently, i.e., that provide packaging containers for the transport, storage and retail display of individually packaged products in a configuration that is visually appealing to a consumer.

### BRIEF DESCRIPTION

Packaging containers suitable for the transport, storage and retail display of individually packaged products are provided. The packaging container comprises a base having or provided with an upper surface sloped from a back end to a front end thereof. Further, the upper surface of the base is provided with one or more discrete areas of a slippery material. The packaging container improves the aesthetics and point of sale presence of the individually packaged products by moving the remaining packaged products toward the front of the container as individual packages are removed by consumers for purchase. As the slippery material is easily applied, and also because other methods of, or features for, enabling or assisting movement of the individually packaged products are not required in order to maintain an individually packaged product in a forward-most position of the container, the containers, and packaging units comprising the containers are readily and easily manufactured.

In one aspect, a single-use packaging container for transporting and/or displaying a plurality of individually packaged products is provided. The packaging container comprises a base having or provided with a downward slope from a back end to a front end thereof. The base further comprises an upper surface provided with one or more discrete areas of slippery material. The packaging container is not adapted to be refilled. As such, the merchant is relieved of the burden of refilling or restocking the container.

Advantageously, the slippery material is applied to less than 50%, or less than 30%, of the upper surface of the base. The slippery material can reduce the coefficient of friction of the upper surface by at least 5%, or more. By minimizing the amount of slippery material applied to the upper surface of the base, cost efficiencies are realized.

In some advantageous embodiments, the slippery material can be applied as a solid, rather than as a liquid, i.e., coating, and in such embodiments, the time and expense associated with application of a liquid substance can be saved. For example, the slippery material can be a tape.

The downward slope of the base has an angle of less than 20°, or less than 15°, or less than 10° from horizontal. The slippery material, in combination with the slope of the base, can be used to maintain the position of individually packaged containers placed within the packaging container in a forward position in the container. The slippery material and slope do so cost effectively and in a manner that is easy to manufacture, and without the use of any other features configured to maintain the individually packaged containers in a forward position of the packaging container.

In another aspect, a packaging unit is provided. The packaging unit comprises the packaging container loaded with a plurality of individually packaged products. The individually packaged products have a face surface and a supporting surface generally perpendicular to each other, such that when a product is placed on its supporting surface, the face surface thereof can be generally vertical. Enhanced visibility of the generally vertical face surfaces enhances consumer shopping experiences by making it easy to see the product of the packaging unit. For additional visual impression, the packaging unit's perimeter can define a shape such as a heart or cat face with ears.

Less than all of the surface area of a surface of the individually packaged products is in contact with the upper surface of the base of the packaging container and the slippery material. Stated another way, the, e.g., a supporting surface of the individually packaged products may have zones of contact that engage the discrete areas of slippery material. In some instances the zones of contact make up less than 10% of the supporting surface and engage at least 90% of the discrete areas of slippery material.

The packaging container and individually packaged products can be provided with coordinating shapes or features that physically and/or visually relate the packaging container and individually packaging products to each other. For example, in some embodiments, a shape-defining perimeter of at least one surface of the individually packaged products coordinates with the shape of a feature of the packaging container. In some instances, the shape of a surface of the individually packaged products can correlated with the shape of a surface, or opening, of the packaging container.

The individually packaged products may comprise any product, and in some embodiments, the individually packaged products comprise a food product, such as a confectionery or pet food product. The individually packaged products can be comprised of any packaging material suitable for packaging food products and may comprise rigid packaging, flexible packaging, or a combination of these.

Because the slippery material is not applied to any surface of the packaging container in its entirety, and may be applied to less than 50%, or even less than 30% of the surface area of a single surface of the packaging container, the packaging container is cost-effective to manufacture. In those embodiments wherein the slippery material is applied as a solid, such as a tape, the expense associated with coating equipment and the time associated with application and drying/curing of a coating can be avoided. The application of the slippery material can be done before, during or after formation of the packaging container. In other words, the application can occur when the packaging container is in its flat state, while it is being manipulated, or after it is formed into a form capable of receiving the individually packaged products.

And so, in another aspect, a method of manufacturing a packaging container suitable for transport and display of individually packaged products is provided. The method comprises providing a blank or flat for the packaging container that is configured/configurable for transformation into said packaging container. The blank or flat comprises a base having or provided with an upper surface configured to have a slope from a back end to a front end thereof once the packaging container is erected.

A slippery material is applied to the upper surface of the base. The slippery material need not, and does not, cover the entire upper surface, and desirably will cover less than 50% of the upper surface. Desirably, the slippery material will be applied to areas of the upper surface of the base expected to come into contact with at least a portion of a supporting surface of individually packaged products loaded in the packaging container. So, the method can further comprise the step of determining the amount, and placement of, the slippery material based on where and how much contact occurs between the upper surface of the base and the individually packaged products.

The blank or flat is manipulated to provide the packaging container, and the slippery material can be applied or provided on the upper surface of the base prior to, while, or after the packaging container is transformed. In some embodiments, the individually packaged products are placed into the packaging container after the slippery surface is applied to the upper surface of the base.

Methods of manufacturing the packaging unit are also provided and comprise manufacturing a packaging container as described above, and loading a plurality of individually packaged products into the packaging container.

### DESCRIPTION OF THE FIGURES

Implementations of the disclosure may be better understood when consideration is given to the following detailed description. Such description makes reference to the following figures wherein:

FIG. 1A is a perspective view of one embodiment of a packaging unit;

FIG. 1B is a perspective view of a further embodiment of a packaging unit;

FIG. 2 is a cross-sectional view of the packaging container shown in FIG. 1B, at line 2-2;

FIG. 3 is a perspective view of multiple packaging containers as shown in FIG. 2, arranged side-by-side to provide a module of packaging containers;

FIG. 4A-G are perspective views of multiple embodiments of a packaging unit, comprising various shapes of individually packaged products and configurations of slippery material; and

FIG. 5A-5C are side views of multiple packaging containers as shown in FIG. 2, stacked to provide a module of packaging containers.

### DETAILED DESCRIPTION

The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced item.

The terms “about”, “approximately” and “substantially” are intended to signify that the item being qualified is not limited to the exact value specified, but includes for example, some slight variations or deviations therefrom, caused by measuring error, manufacturing tolerances, stress exerted on various parts, wear and tear, or combinations of these.

Reference throughout the specification to “one example” or “an example” means that a particular feature, structure, or characteristic described in connection with an embodiment or example is included in at least one embodiment. Thus, the appearance of the phrases “in one example” or “in an example” in various places throughout the specification does not necessarily indicate reference to the same embodiment. Further, the particular features, structures or characteristics may be combined in any suitable manner in one or more embodiments. And so, similarly, the phrase “in one embodiment” in various places in the specification are not necessarily referencing the same embodiment, although the inventive concepts disclosed herein are intended to encompass all combinations and permutations including one or more features.

Packaging containers and units for transporting and/or displaying a plurality of individually packaged products are provided. The packaging container improves the aesthetics and point of sale presence of the individually packaged products by moving the remaining packaged products toward the front of the container as individual packages are removed by consumers for purchase. The packaging container is adapted to be used as an on-shelf display following transport, whereby the amount of manual manipulation required to display the individually packaged products in an aesthetically pleasing and effective manner at the point of retail sale is minimized.

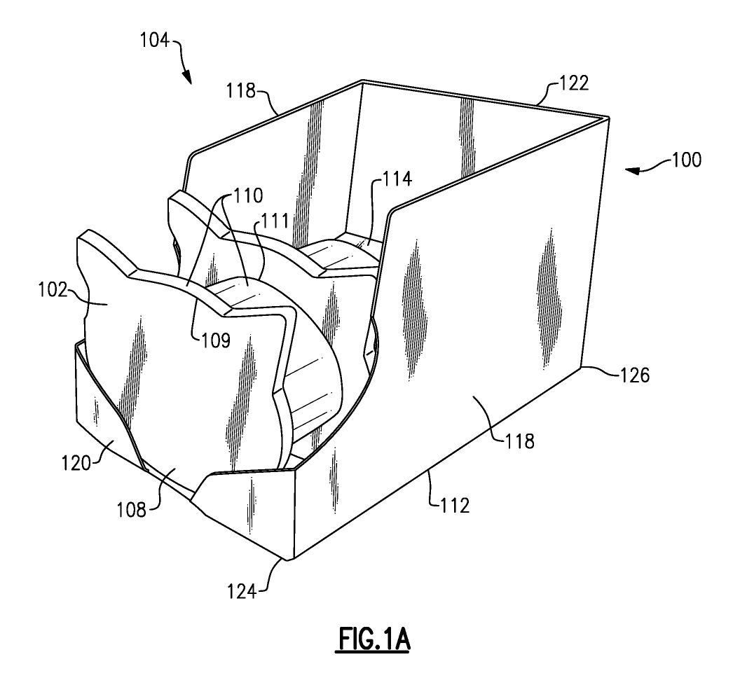

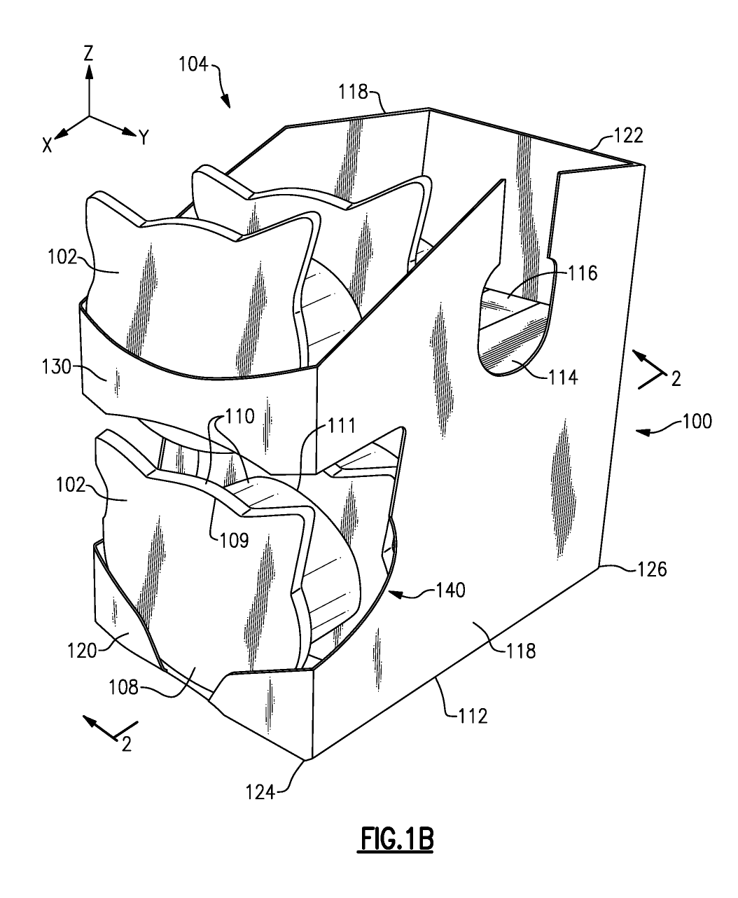

One embodiment of such a packaging container is shown in FIGS. 1A and 1B. As shown, the packaging container 100 comprises a base 112 having or provided with an upper surface 114 provided with a downward slope extending from a back end 126 of the base to a front end 124 of the base 112, and provided with one or more discrete areas of slippery material 116.

The base 112 of the packaging container 100 has two side panels 118, as well as a front panel 120 and rear panel 122 extending upwards therefrom in a generally perpendicular direction, thereby defining an interior void into which the individually packaged products may be placed. The front panel 120 is defined as the forward-most portion of packaging container 100 intended to be displayed toward the customer. The front panel 120 and rear panel 122 define a front end 124 and a rear end 126, respectively, of the base 112.

The base has, or is provided with, an upper surface 114 and a lower surface (not shown), the lower surface being the surface which faces outside of the packaging container 100 and contacts the surface of a shelf when the packaging container 100 is placed in a display and/or dispensing position. The base 112 may be any generally planar shape and may advantageously be square or rectangular.

The upper surface 114 of the base 112 faces internally to the packaging container 100 and forms the base surface onto which the individually packaged products 102 are placed for storage, transport and display.

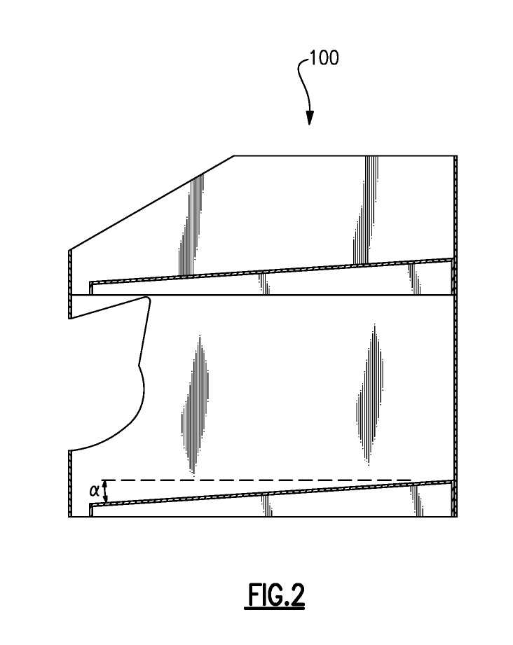

The upper surface 114 of base 112 is provided with a slope extending downward from the rear panel 122 toward the front panel 120. FIG. 2 is a cross-sectional view, taken along line 2-2, of the packaging unit shown in FIG. 1B, wherein the downward slope of the upper surface 114 from the back end 126 to the front end 124 of the base 112 is shown.

Generally speaking, angle a will desirably provide a sufficient slope to the upper surface 114 of base 112 to assist in the movement of individually packaged products 102 from the back end 126 to the front end 124 of base 112, while also not providing upper surface 114 with a slope so steep as to distract from the visual impact of the forward-most individually packaged product 102 or visual appeal of the overall display, or such that the individually packaged products 102 are liable to be ejected from the packaging. For example, angle a may be less than 20°, or less than 15°, or less than 10°. Angle α will also desirably be greater than 2°, or greater 5°. In some embodiments, angle α will be between 5° and 15°.

One or more areas of slippery material 116 is/are applied to the upper surface 114 of the base 112. Advantageously, the slippery material 116 need not be applied to the entirety of the upper surface 114 of base 112 and yet, the individually packaged products 102 can be assisted in moving from the back end 126 of the base 112 to the front end 124 of the base 112. Cost and time savings are thus provided. Typically, less than 50%, or less than 40%, or less than 30%, or even less than 20% of the upper surface 114 of the base 112 may have the slippery material 116 applied thereto.

The slippery material 116 can be any material that is effective to reduce the coefficient of friction of the upper surface 114 of the base 112, and thus to decrease the frictional force between the individually packaged products 102 and the upper surface 114 of the base 112. Materials having a coefficient of from 0.04 to 0.5 are believed to be capable of doing so and are suitable. Examples of suitable materials include Teflon®, which has a coefficient of friction of 0.04, plastics such as polyethylene, which has a coefficient of friction in the range of from 0.12-0.5, patterned polypropylenes which have a coefficient of friction from 0.1 to 0.15 or self-adhesive tensilized polypropylene with a range of coefficients of friction of from about 0.03 to about 0.4. Such materials can desirably reduce the coefficient of friction of the upper surface 114 to which it is applied by at least 5%, or more.

The slippery material 116 can be applied in any known fashion, such as by adhesion/pressure, spraying, painting, electrostatic adhesion, etc. In some advantageous embodiments, the slippery material 116 can be applied in the form of a solid, rather than a coating, and by in such embodiments, the time and expense associated with application of a liquid substance can be saved. For example, the slippery material can be a tape.

The slippery material 116 may be coated or applied to the desired area of the upper surface 114 of the base 112 as a single line, as a pattern, or a plurality of lines or row, each of which may desirably be generally linear or curvilinear. The plurality of rows may be separated by an area of the upper surface 114 of base 112. The rows may desirably be continuous from the back end 126 to the front end 124 of the base 112 and run generally parallel to the side panels 118. One, two, three, four or more such rows may be provided, and when multiple rows are provided they may be separated by an area of upper surface 114 of base 112. Desirably, no more than 50% of the surface area of upper surface 114 is covered by slippery material 116.

The packaging container 100 may be provided with one or more tiers configured to accept individually packaged products 102. Such an embodiment is shown in FIGS. 1B and 2-5. In such embodiments, each tier 130 is provided with a base 112 and sloped upper surface 114 thereof. Such embodiments are advantageous in that they provide for increased visual presence of individually packaged products 102 within the same shelving area as single tiered embodiments (shown in FIG. 1A).

The packaging container 100 may be made from any material commonly known in the art of transport and display packaging containers. Suitable examples include paperboard, cardboard, wood, metals, fiberboard, corrugated paperboard, plastic trays, or combinations of these. In certain advantageous embodiments, the packaging container 100 is manufactured from paperboard or corrugated paperboard which is a layered construction of paper-based liners and paper-based fluting material that gives the paperboard mechanical strength. Such material has sufficient strength to be suitable for use in the transport and display of the individually packaged containers 102, but yet is economical enough to be used in a packaging container 100 that is adapted for a single use, i.e., that is not adapted or contemplated for refilling.

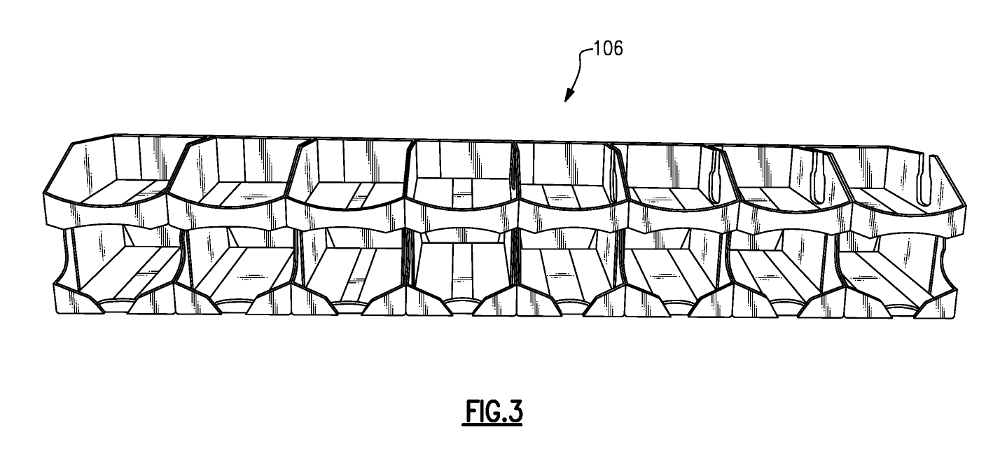

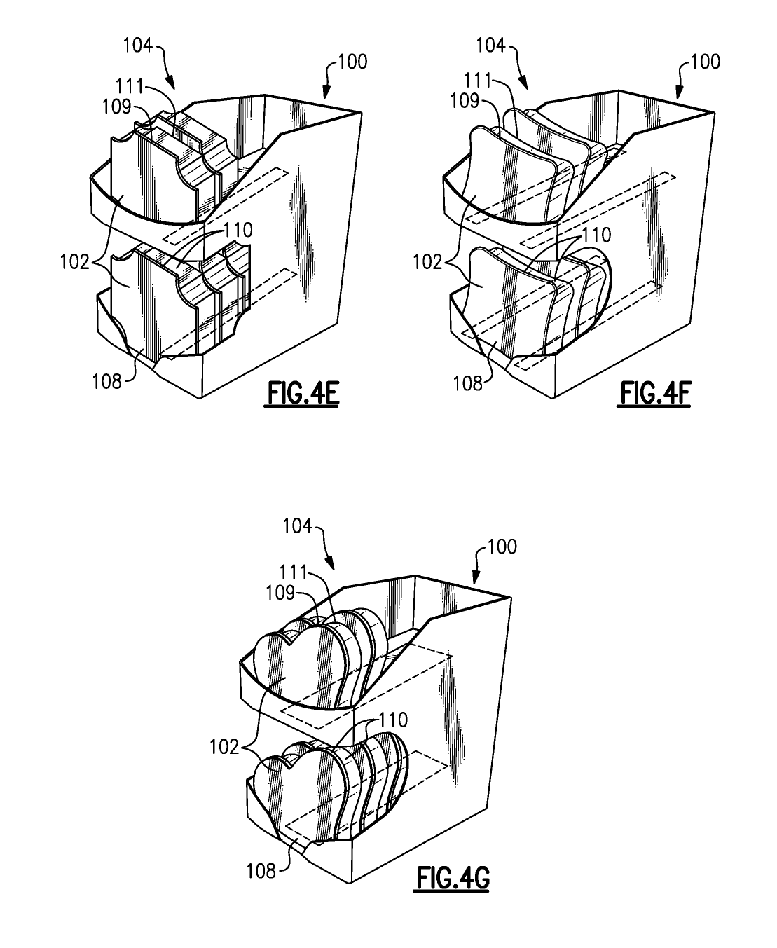

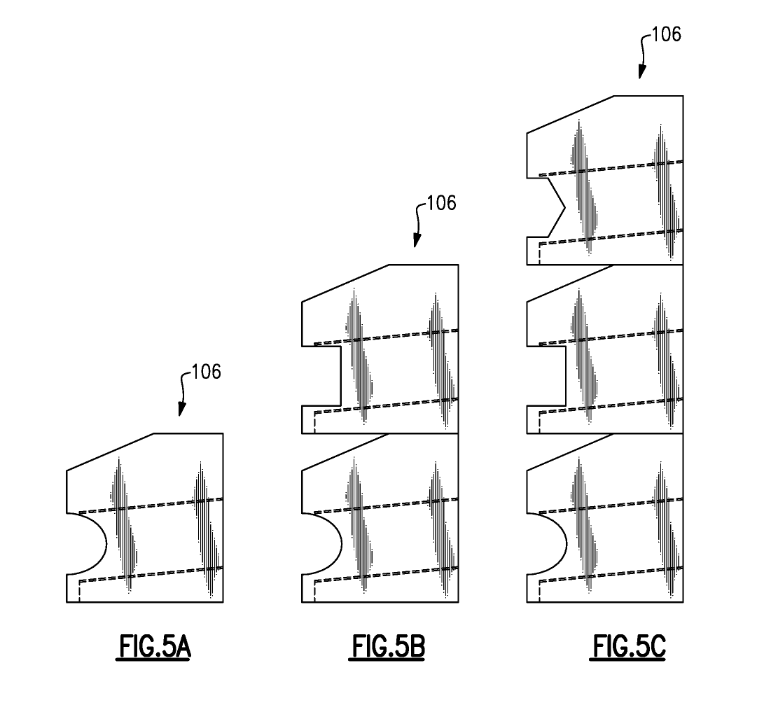

Several packaging containers 100, having one or more tiers, may be provided in combination, i.e., stacked or arranged linearly, to provide modules of packaging containers 100 (or packaging units if packed with individually packaged products 102) as shown in FIGS. 3 and 5A-5C. As with multi-tiered embodiments, stacking of single tiered or even multi-tiered embodiments can be advantageous in that the visible area of individually packaged products 102 can be increased, while not occupying additional shelf space.

A packaging unit 104 is also provided. One embodiment of the packaging unit 104 is shown in FIG. 1A and comprises the packaging container 100 loaded with a plurality of individually packaged products 102. The individually packaged products 102 have a face surface 108 having a lip 109 and one or more supporting surfaces 110 generally perpendicular to each other.

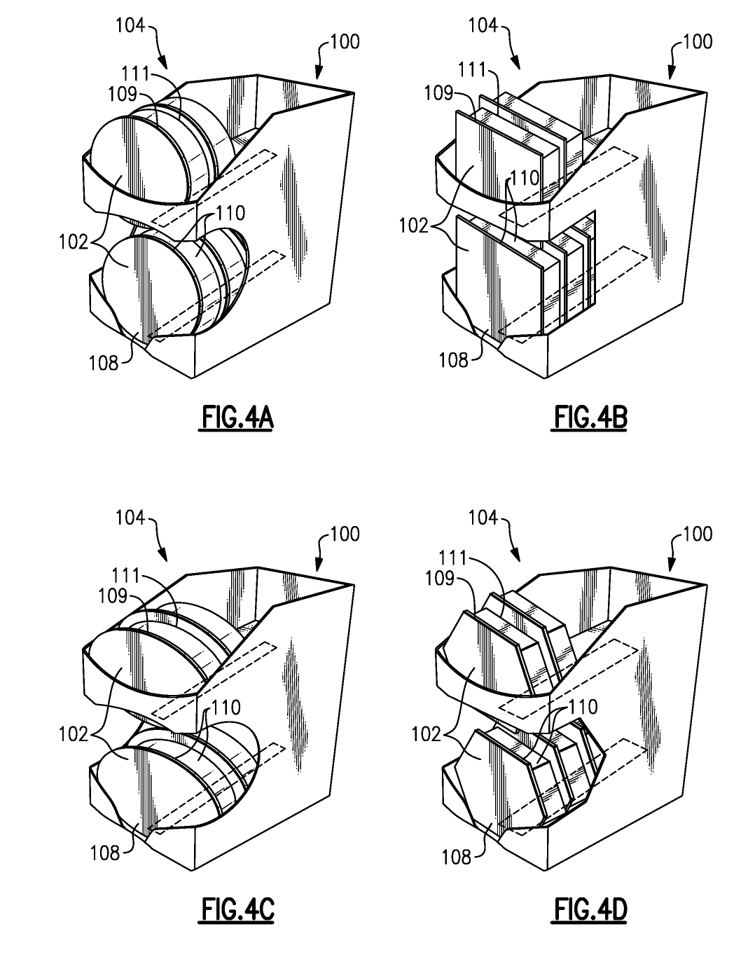

Individually packaged products 102 suitable for loading into the packaging container 100 include food products for human or pet consumption, such as for example, confectionery and pet food products or treats. The individually packaged products 102 may desirably be packaged as individual units in rigid or flexible packaging, or a combination of these. The individually packaged products 102 may be any shape, or combination of shapes. A variety of suitable shapes are shown in FIGS. 4A-4G and include circular, square, oval, octagon, pillow or heart shaped. As shown in FIGS. 1A and 1B, the individually packaged products may have a surface 108 in the shape of the face and ears of a cat, or other pet.

In some embodiments, a feature of the packaging container 100 and the individually packaged products 102 may be coordinated, i.e., may bear a physical resemblance to each other. For example, an opening 140 of packaging container 100 through which the individually packaged products 102 may be accessed may have a shape similar to the shape of a surface defined by a perimeter of the individually packaged products. As shown in FIG. 1B, the packaging container 100 has an opening 140 having the shape of the head of a cat and similar to that of the surface 108 having a perimeter of individually packaged products 102. FIGS. 4A through 4E show other embodiments wherein an opening of the packaging container 100 coordinates with a shape of individually packaged products 102.

The individually packaged products 102 are desirably oriented in the packaging unit 104 so that the front surface 108 thereof faces toward the opening 140 of the packaging container 100. To do so, the lip 109 and/or supporting surface 110 of the individually packaged products will be arranged so that portions of lip 109 and/or the supporting surface 110 contact the upper surface 114 of the base 112. The entirety of the supporting surface 110, or the lip 109, need not be in contact with the upper surface 114. Those portions of lip 109 and supporting surface 110 that do desirably contact the slippery material 116 thereby providing zones of contact between the individually packaged products 102 and the slippery material 116.

In those embodiments wherein the supporting surface 110 of the individually packaged products is not linear and/or contiguous, such as where the individually packaged products have a base 111 of smaller dimensions than the front surface 108 and lip 109 of the individually packaged products 102, as shown in FIGS. 1A and 1B, such placement may result in individually packaged products leaning back relative to the front end 124 of the base 112. Such an orientation can be preferred, as it provides a greater stability to the individually packaged products and can further increase the visual appeal of the packaging unit.

And so, the individually packaged products 102 may be packed into the packaging container 100 so that they are inclined toward the rear panel 122 of the packaging container 100. For example, the individually packaged products 102 can be inclined toward the rear panel 122 of the packaging container 100 at an angle of greater than 0° to about 30° from vertical. The degree of this angle can be modified by increasing or decreasing the size of the lip 109 that extends beyond the base 111 of the individually packaged products 102. Such a packing angle maintains the stability of the individually packaged products 102 in transport, and while on display, even after the first few individually packaged products 102 have been removed from the packaging container 100.

Once packed into the packaging container 100, the supporting surface(s) 110 have zones of contact that engage with the areas of slippery material 116 in packaging container 100. The zones of contact can include supporting surface(s) 110 from both the base 111 and the lip 109 of the individually packaged product(s) 102. That is, the entire area of supporting surface 110 need not be in contact with the areas of slippery material 116 in order for the advantages of the present invention to be seen. Instead, in some embodiments, these zones of contact are discrete and represent only a small percentage of the surface area of supporting surface 110, e.g., the zones of contact of supporting surface(s) 110 that engage with the slippery material can be less than 50%, or less than 40%, or less than 30%, or less than 20% or even less than 10% of the surface area of supporting surface 110.

The packaging unit may further comprise a lid or cover (not shown). The lid may be separately manufactured and placed over the packaging container in a separate step after packing the individually packaged products 102 into the packaging container 100. Alternatively, the lid may be manufactured in conjunction with the rest of the packaging container 100 and provided with perforations or some other means of detachment. The lid will desirably be easily removed following transport to enable display of the individually packaged products 102 at the point of sale without their removal from the packaging container. In this manner, the packaging container 100, with the lid removed, may be placed directly onto a retail shelf with the individually packaged products 102 prepacked therein.

Because the slippery material 116 is not applied to any surface of the packaging container 100 in its entirety, and may be applied to less than 50%, or even less than 30% of the surface area of a single surface of the packaging container 100, the packaging container 100 is cost-effective to manufacture. In those embodiments wherein the slippery material 116 is applied as a solid, such as a tape, the expense associated with coating equipment and the time associated with application and drying/curing of a coating can be avoided.

A method of manufacturing a packaging container suitable for transport and display of individually packaged products is thus also provided. The method comprises providing a blank or flat for the packaging container that is configured for erection into said packaging container.

The use of carton blanks as precursors for a packaging containers 100 is common in the art. Such blanks are manufactured and shipped flat, with fold lines or perforations provided therein, and erected at a point of loading and shipping by folding the blank at the fold lines and adhering the various folded panels in place using conventional attachment means such as an adhesive, staples or the like. Methods of assembling packaging containers 100 from blanks are per se known in the art.

Suitable blanks comprise a base 112 having an upper surface 114 configured to have a slope from a back end 126 to a front end 124 thereof once the packaging container 100 is erected. The packaging container 100 may be manufactured using more than one blank, wherein one blank is erected to form the outer structure of the container, and a second blank is provided and erected to provide the desired sloped upper surface(s) 114. In such embodiments, the second blank or insert may be used to provide additional tiers 130 within the packaging container 100, or additional blanks may be provided and used for this purpose. In such embodiments involving a second blank, the second blank can be used to provide upper surface 114. Those of ordinary skill in the art would be capable of implementing any design, utilizing any number of second blanks to provide a packaging container having at least one sloped upper surface 114.

Alternatively, the packaging container 100 may be manufactured by providing a container base and separate side, front and rear panels and optionally a lid and erecting or assembling the individual parts, including any desired second blank inserts, into a packaging container 100 by attaching the sides, front and rear panels to the base, optionally inserting a second blank, followed by the packing therein of individually packaged products 102 and the attachment of the optional lid.

A slippery material 116 is applied to the upper surface 114 of the base (which can be the upper surface of an inserted second blank), and may be applied prior to, during or after the transformation of the blank, or individual components, into the packaging container 100. The slippery material 116 need not, and does not, cover the entire upper surface 114, and desirably will cover less than 50% of the upper surface 114. Desirably, the slippery material 116 will be applied to areas of the upper surface 114 of the base 112 expected to come into contact with the zones of contact of the supporting surface 110 of the individually packaged products 102 loaded in the packaging container 100. The method can further comprise the step of determining the amount, and placement of, the slippery material.

Following transformation of the blank, or individual components, into a packaging container 100, the packaging units 104 may be manufactured by loading a plurality of individually packaged products 102 into the packaging container 100. The individually packaged products 102 are placed so that the zones of contact of the supporting surface 110 and/or lip 109 come into contact and engagement with slippery material 116. In some embodiments, the individually packaged products 102 will be placed within the packaging container 100 at an angle of greater than 0° to 30° from the vertical.

### EXAMPLE

A number of blanks are provided corresponding to a base, and an insert of the packaging container. The base blank has front, back and two side panels joined at fold lines. Each of these panels is provided with base portions adapted to be folded perpendicularly to the panels to provide a base of the packaging container 100. The front, and optionally side panels may be provided with corresponding, attached removable portions to provide an opening in the assembled packaging container. The blank is folded along the fold lines between the panels, to provide a rectangularly shaped tube, and the base portions folded towards the inside of the rectangular tube to provide a packaging container having an internal void. At least one seam is provided to attach the, e.g., rear panel to a side panel of the blank, and a second may be provide to adhere one base portion to another. Any suitable adhesive or attachment means is used.

A base having a sloped upper surface is provided within the internal void of the formed packaging container via another blank, which may generally comprise one or more base portions connected at fold lines and adapted to provide angle α once folded and inserted into packaging container 100.

Slippery material, e.g., self-adhesive tensilized polypropylene tape, is applied in the form of a single row extending from the back end of the upper surface of the base to the front end of the upper surface of the base. The slippery material is provided as tape, cut to the desired size and applied in the desired location to provide a packaging container in accordance with one embodiment.

Once assembled, a plurality, e.g., 10 to 20 individually packaged products 102 comprising, e.g., pet food or confectionery products are placed into the packaging container 100. The individually packaged products 102 are placed into the packaging container 100 so that zones of contact of the supporting surfaces 110 and lip 109 thereof come into engagement with the slippery material 116. The packaging unit 104 is transported to a place of retail sale, where the lid or cover is removed and the packaging unit 104 is thereafter placed directly onto a display shelf for retail sale. Even after the first few individually packaged products 102 are removed from the packaging container 100, the remaining individually packaged products 102 move toward the front of the packaging container 100, thereby maintaining the aesthetics and point of sale presence of the remaining individually packaged products 102 within the packaging container 100.

Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

1. A packaging container for transporting and/or displaying a plurality of individually packaged products containable therein, the packaging container comprising:
a base having a downward slope from a back end to a front end thereof, the base further comprising an upper surface provided with one or more discrete areas of slippery material.

2. The packaging container of claim 1, wherein the container is not adapted to be refilled/is adapted for a single use.

3. The packaging container of claim 1, wherein less than 50% of the upper surface is provided with the slippery material.

4. The packaging container of claim 3, wherein the slippery material is a tape.

5. The packaging container of claim 1, wherein the slippery material reduces the coefficient of friction of the areas of the upper surface to which it is applied by at least 5%.

6. The packaging container of claim 1, wherein the downward slope of the base has an angle of less than 20° from horizontal.

7. The packaging container of claim 1, wherein the upper surface is formed from an insert.

8. The packaging container of claim 1, wherein the packaging container comprises no other features configured to maintain the individually packaged containers in a forward position of the packaging container.

9. The packaging container of claim 1, comprising multiple tiers.

10. A packaging unit comprising:
a packaging container comprising a base having a downward slope from a back end to a front end thereof, the base further comprising an upper surface provided with one or more discrete areas of slippery material; and
a plurality of individually packaged products having a face surface and a supporting surface generally perpendicular to each other.

11. The packaging unit of claim 10, wherein a shape defined by a perimeter of at least one of the individually packaged products coordinates with an opening of the packaging container.

12. The packaging unit of claim 10, wherein the supporting surface of the individually packaged products have zones of contact that engage the discrete areas of slippery material.

13. The packaging unit of claim 12, wherein the zones of contact make up less than 10% of the supporting surface and engage at least 90% of the discrete areas of slippery material.

14. The packaging unit of claim 10, wherein the individually packaged products comprise rigid packaging, flexible packaging, or a combination of these.

15. The packaging unit of claim 10, wherein the individually packaged products comprise pet food products or confectionery.

16. A method of manufacturing a packaging container suitable for transport and display of individually packaged products comprising:
providing a first blank for the packaging container that is configured for transformation into said packaging container, the blank comprising a base having or provided with an upper surface having a slope from a back end to a front end thereof once the packaging container is transformed; and
applying a slippery material to discrete areas of the upper surface of the base.

17. The method of claim 16, wherein the upper surface of the base is provided with an upper surface via a second blank configured for transformation and insertion into the erectable packaging container.

18. The method of claim 16, further comprising determining the amount of solid, slippery material to apply prior to applying the solid, slippery material.

19. The method of claim 16, wherein the step of applying comprises applying a slippery tape to less than 50% of the surface area of the upper surface of the base.

20. The method of claim 16, further comprising transforming the blank into a packaging container.
